(19) United States
(12) Patent Application Publication
(10) Pub. No.: US 2025/0204489 A1
(43) Pub. Date: Jun. 26, 2025

(54) SYSTEM FOR LOCATION MONITORING AND USES THEREOF

(71) Applicant: PROTAG LIMITED, Whangaparaoa (NZ)

(72) Inventors: Tyrel Leon GLASS, Te Aroha (NZ); Baden Matthew Tully PARR, Auckland (NZ)

(73) Assignee: PROTAG LIMITED, Whangaparaoa (NZ)

(21) Appl. No.: 18/849,040

(22) PCT Filed: Mar. 22, 2023
(86) PCT No.: PCT/NZ2023/050035

§ 371 Date: Sep. 20, 2024

(30) Foreign Application Priority Data
Mar. 22, 2022 (AU) 2022900715

(51) Int. Cl. A01K 11/00; G01S 19/48

(52) U.S. Cl. CPC A01K 11/008; G01S 19/48

(57) ABSTRACT

The present invention relates to a system (100) for determining the location of a number of animals in a group of animals, comprising a first number of first mobile devices (10A-10C) forming anchor devices, each configured to be attached to an animal of a first subgroup of the group of animals, each first mobile device (10A-10C) comprising a satellite positioning unit (11) for detecting a precise location of the first mobile device (10A-10C), and a first radio frequency (RF) unit (12) for transmitting a low power RF signal, a second number of second mobile devices (20A-20J) forming roaming devices, each configured to be attached an animal of a second subgroup of the group of animals, each second mobile device (20A-20J) comprising a second radio frequency (RF) unit (21) for receiving one or more RF signals transmitted by the first number of first mobile devices (10A-10C), and a second controller (22) configured to determine a location or relative location of the second mobile device (20A-20J) based on the one or more received RF signals utilizing an RF mesh positioning technique.

### TECHNICAL FIELD

The invention relates to a system and methods for real time detection of the location, and in certain embodiments other characteristics such as the behaviour, of one or more individuals in a plurality of animals. The system comprises receiver/transmitter devices attached to the animals, data from which is used to calculate the location of one or more of the animals.

### BACKGROUND OF THE INVENTION

The following includes information that may be useful in understanding the present inventions. It is not an admission that any of the information provided herein is prior art, or relevant, to the presently described or claimed inventions, or that any publication or document that is specifically or implicitly referenced is prior art. Any discussion of the prior art throughout the specification should in no way be considered as an admission that such prior art is widely known or forms part of the common general knowledge in the field.

Understanding the physical location and/or status of animals, particularly livestock animals, is important for both animal well-being and for efficient agricultural production. While visual monitoring is possible, and may be practical particularly at a small scale, other methods of determining the movements and location of one or more individual animals within a group, for example all members of a group, facilitate modern agricultural methods and practices.

A number of animal tracking systems have been proposed which utilize multiple fixed base stations of known location that can be used to determine the relative position of one or more animals. However, existing solutions pose several drawbacks that are either not addressed adequately or need to be compensated for, making their use disruptive and impractical. Further, these systems can be complex to implement and challenging to adapt should circumstances (such as the number of individuals to be monitored) change. Accuracy can also be dependent on proximity to a base station.

For example, existing solutions can require a receiver to use a lot of power to detect and/or decode transmitted information/signals. Further, some transmitted signals are not suitable for certain environments, such as indoors or enclosed spaces, resulting in poor signal transmission or “multipath” issues where multiple versions of the same signal are created due to reflection of signals.

There remains a need for an efficient, configurable and flexible system for locating one or more individual animals within a group of animals, and particularly one with a high degree of accuracy in both the spatial and temporal domains.

It is therefore an object of the invention to provide a system and related methods for locating one or more animals in a group of animals that at least in part addresses this need, or to at least provide a useful alternative to existing methods, or to at least provide the public with a useful choice.

### SUMMARY OF THE INVENTION

According to a first aspect a system for determining the location of a number of animals in a group of animals is provided. The system comprises a first number of first mobile devices forming anchor devices, each configured to be attached to an animal of a first subgroup of the group of animals. Each first mobile device comprising a satellite positioning unit for detecting a precise location of the first mobile device, and a first radio frequency (RF) unit for transmitting a low power RF signal. Further, the system comprises a first controller for controlling the operation of the satellite positioning unit and the first RF unit. Moreover, the system comprises a second number of second mobile devices forming roaming devices, each configured to be attached an animal of a second subgroup of the group of animals. Each second mobile device comprises a second radio frequency (RF) unit for receiving one or more RF signals transmitted by the first number of first mobile devices. The second mobile device may further comprise a second controller configured to determine a location or relative location of the second mobile device based on the one or more received RF signals utilizing an RF mesh positioning technique.

The low power RF signal may comprise information associated with the precise location of the associated first mobile device.

The first controller may be configured to cause the first RF unit to transmit the low power RF signal in accordance with a sequence order assigned for each first mobile device, thereby allowing each first mobile device, by its first controller, to transmit the associated low power RF signal in turn.

The second controller may be configured to cause the second RF unit to listen for low power RF signals in accordance with the sequence order of each first mobile device.

The RF mesh positioning technique may be based on triangulation and/or by determining the received signal strength (RSS), and/or the Angle of Arrival (AoA), and/or Angle of Departure (AoD) of the RF signal.

The first number of first mobile devices may be lower than the second number of second mobile devices.

The first number of first RF units and the second number of second RF units may be configured to form a low power RF partial or full mesh network.

The satellite positioning unit may be a Global Navigation Satellite System (GNSS) unit, such as a Global Positioning System (GPS), or GLONASS unit. The GNSS unit may be an assisted GPS unit arranged to receive Almanac and Ephemeris data using a Long Range Wide Area Network (LoRaWAN) communications protocol from a remote stationary device.

Each first mobile device may further comprise a first transceiver arranged to transmit and/or receive said Almanac and Ephemeris data to/from another first mobile device. The first transceiver may be configured to transmit/receive information using a LoRaWAN, Bluetooth, or Zigbee protocol. The first transceiver may be further arranged to receive a precise location of a remote stationary GNSS receiver or external device with a known location.

The second radio frequency (RF) unit may be further configured to: determine its location in relation to the precise location of the remote stationary GNSS receiver based on the one or more received RF signals utilizing an RF mesh positioning technique.

At least one of the first number of first mobile devices and/or at least one of the second number of second mobile devices may further comprise at least one of the following: a motion detector such as an accelerometer or gyroscope, an orientation detector such as a magnetometer, an audio sensor such as a microphone, or a temperature sensor, and/or a heart rate monitor.

The motion detector, orientation detector, audio sensor, temperature sensor, and/or a heart rate monitor may be operatively coupled to the respective first controller and/or second controller.

The first mobile device and/or the second mobile device may further comprise: a solar panel for providing power to at least one of: the respective satellite positioning unit, the first RF unit, the second RF unit, the first controller, or the second controller.

The first controller may be further configured to: activate the satellite positioning device only during a determined first recurring time period, and control the first radio frequency (RF) unit to transmit a low power RF signal during a predetermined second time period subsequent to the first time period.

The first controller or second controller may be further configured to: access information from the motion detector or orientation detector, and determine a temporary location of the associated first mobile device or second mobile device with reference to a previously determined location of the associated first or second mobile device using a dead reckoning technique based on the accessed information continuously, at regular time intervals, or when prompted by a user via a graphical user interface.

The first mobile device and/or the second mobile device may pertain to at least one of: a tag, such as an ear tag, configured to be attached to an ear of the associated animal, a collar configured to be attached around the neck of the associated animal, a pedometer, and a bracelet.

The system may further comprise a remote device for receiving data from the first mobile device(s) and/or the second mobile device(s), and a graphical user interface configured to: present the received data, and/or control operation parameters of the first mobile device(s) and/or second mobile device(s).

The remote device and/or the graphical user interface may form part of a mobile phone, smart phone, tablet, smart watch, computer and/or display device.

Each first mobile device of the first number of first mobile devices may be selected based on an anchor selection sequence carried out locally by the first controller or externally on a cloud-based service device.

When the anchor selection sequence is set to be carried out locally, when a certain criterion for requesting for replacement is met, the associated first controller may be further configured to: transmit, by the associated first RF unit, a replacement signal associated with a request for replacement when a certain criterion for replacement is met, receive one or more RF response signals in response to its transmitted replacement signal from a second mobile unit, identify the second mobile unit whose RF response signal is best suited for the replacement, transmit an RF confirmation signal for receipt by the identified second mobile unit, receive an RF affirmation signal from the identified second mobile unit, and in response to the RF affirmation signal, reset the operation of the associated first mobile unit acting as an anchor device to that of a second mobile unit acting as a roaming device.

When the anchor selection sequence is set to be carried out locally, each second controller may be configured to: receive, by the associated second RF unit, a replacement RF signal from a first controller, and in response to said received replacement signal, transmit an RF response signal comprising information about its associated second mobile device's suitability to replace the first mobile device associated with the transmitted the replacement signal as a new anchor device, receive an RF confirmation signal from the first controller transmitting the RF replacement signal, and in response thereto, transmit an RF affirmation signal confirming the replacement, and reset the operation of the associated second mobile unit acting as a roaming device to that of a first mobile unit acting as an anchor device.

### BRIEF DESCRIPTION OF THE FIGURES

FIG. 1 illustrates a system of first and second mobile devices according to an embodiment, wherein one first mobile device receives precise location information from a number of GNSS satellites;

FIG. 2 illustrates a system of first and second mobile devices according to an embodiment, wherein a number of first mobile device respectively receives precise location information from a number of GNSS satellites;

FIG. 3 illustrates a system of first and second mobile devices according to an embodiment, wherein a first mobile device transmits a low power RF signal;

FIG. 4 illustrates a system of first and second mobile devices according to an embodiment, wherein each first mobile device transmits an associated low power RF signal;

FIG. 5 illustrates a system of first and second mobile devices according to an embodiment, wherein a second mobile device transmits an associated low power RF signal;

FIG. 6 illustrates a system of first and second mobile devices according to an embodiment, wherein a second mobile device receives the respective low power RF signal from the associated first mobile devices;

FIG. 7 illustrates a system of first and second mobile devices according to an embodiment, after an anchor selection or replacement process has been carried out, resulting some of the former second mobile devices now acting as first mobile devices, and some of the former first mobile devices now acting as second mobile devices;

FIG. 8 illustrates localisation of a target mobile device using lateration;

FIG. 9 illustrates localisation of a target mobile device using angulation;

FIG. 10 illustrates localisation of a target mobile device using angulation utilizing Angle of Arrival with lateration;

FIG. 11 illustrates localisation of a target mobile device using angulation utilizing Angle of Departure;

FIG. 12 illustrates localisation of a target mobile device using angulation utilising Angle of Departure with lateration;

FIG. 13 illustrates a system according to an embodiment;

FIG. 14 illustrates a view of a mobile device showing the associated antenna array according to an example;

FIG. 15 illustrates the general concept of using two spaced apart antennas (of an antenna array) both receiving the same signal transmitted from a transmitter, to detect an associated phase difference which in turn may be used to determine the angle to the transmitter; and

FIGS. 16A and 16B illustrates the apparent AoA for different orientations of the mobile device when receiving a signal from the transmitter.

### DETAILED DESCRIPTION

The present invention relates to systems and methods for accurately determining the location of one or more animals in a group of animals.

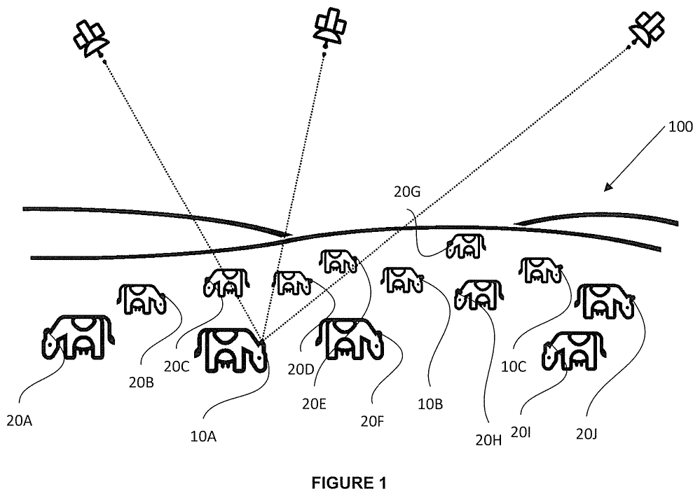

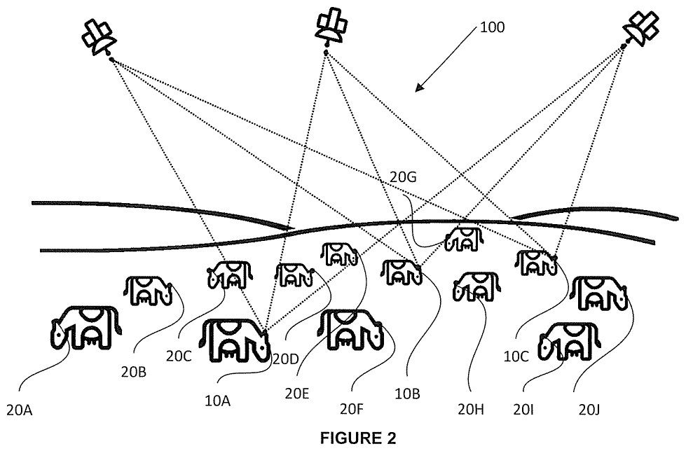

In an embodiment, with reference to FIGS. 1 to 6 and 13, a system 100 for determining the location of a number of animals in a group of animals is provided. The system comprises a first number of first mobile devices 10A-10C forming “anchor devices”, each configured to be attached to an animal of a first subgroup of the group of animals. Further, the system comprises a second number of second mobile devices 20A-20J forming “roaming devices”, each configured to be attached to an animal of a second subgroup of the group of animals.

In particularly contemplated embodiments, the system 100 comprises multiple mobile devices 10, 20, each of which is configured to be attached to an animal. The multiple mobile devices of the system comprise a first number of first mobile devices 10A-10C, and a second number of second mobile devices 20A-20J.

In one embodiment, the first mobile devices 10A-10C are physically and/or functionally different to the second mobile devices 20A-20J.

In one embodiment, the mobile devices are each physically similar or identical, but are capable of being configured in two or more modes differing in the functionalities activated. In some embodiments, the each first mobile device is configured to operate in a first mode of operation, while each second mobile device is configured to operate in a second mode of operation. In some embodiments, the operation mode of a second mobile device (i.e., a roaming device) can be changed to that of a first mobile device (i.e., an anchor device), and/or vice versa.

In one example, the mobile devices having or configured to have a first set of functionalities comprise a first number of mobile devices 10A-10C, and the mobile devices having or configured to have a second set of functionalities comprise a second number of mobile devices 20A-20J.

One or more of the multiple mobile devices will in various embodiments comprise a satellite positioning unit for detecting a precise location of the respective mobile device. Further, one or more of the multiple mobile devices will in various embodiments comprise a radio frequency (RF) unit for transmitting and/or receiving a low power RF signal and a controller configured to, for example, control the operation of the satellite positioning unit and/or the RF unit and/or determine a location or relative location of the mobile device.

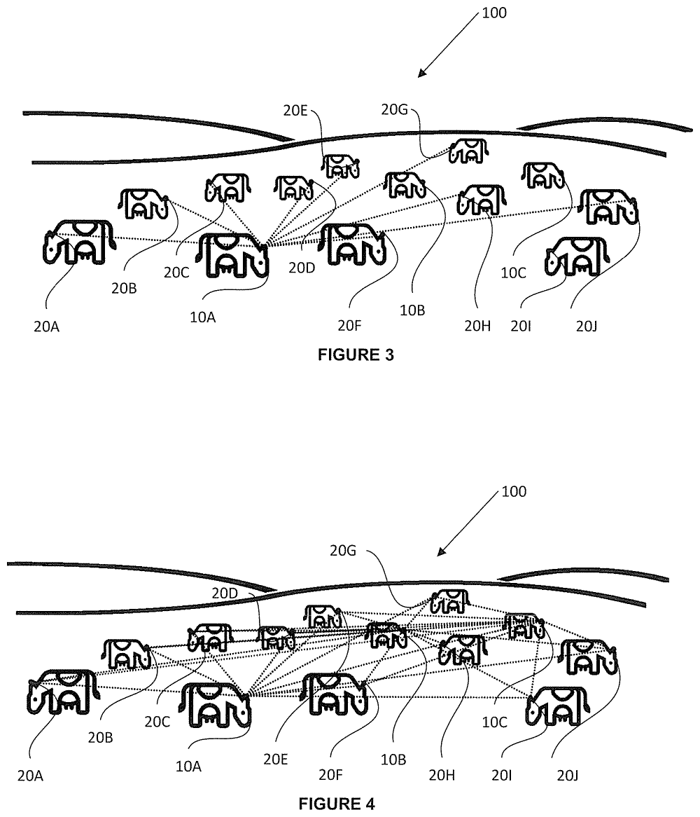

With reference to FIGS. 1, 2, and 13, each first mobile device 10A-10C may comprise a satellite positioning unit 11 for detecting a precise location of the respective first mobile device 10A-10C. With reference to FIGS. 3 and 4, each first mobile device 10A-10C may comprise a first RF unit 12 for transmitting a low power RF signal. Moreover, each first mobile device 10A-10C may comprise a first controller 13 for controlling the operation of the satellite positioning unit 11 and the first RF unit 12.

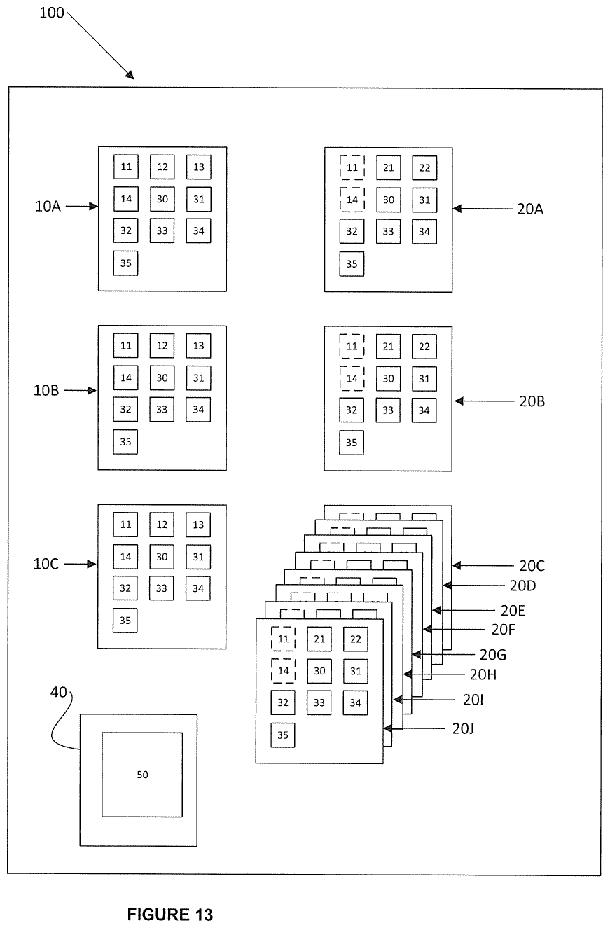

As shown with reference to FIGS. 6 and 13, each second mobile device 20A-20J may comprise a respective second RF unit 21 for receiving one or more RF signals transmitted by the first mobile devices 10A-10C. Further, each second mobile device 20A-20J may comprise a respective second controllers 22 configured to determine a location or relative location of the second mobile device 20A-20J based on the one or more received RF signals and utilizing an RF mesh positioning technique (discussed in detail below). With reference to FIG. 6 a second mobile device 201 may be seen receiving a respective RF signal transmitted from each of the first mobile devices 10A, 10B, and 10C. The second controller of the second mobile device 201 may be configured to process the received RF signals (three in this case) for determining its location or relative location relating to the first mobile devices accordingly.

In one embodiment, one or more of the mobile devices, such as one or more of the first mobile devices, is configured in a first mode in which, when present, the satellite positioning unit is or is capable of being activated.

In one embodiment, one or more of the mobile devices, such as one or more of the second mobile devices, is configured in a second mode in which, when present, the satellite positioning unit is not activated. Hence, while the second mobile device may comprise a satellite positioning unit 11, similarly to the first mobile device, said satellite positioning unit 11 is not activated when the associated mobile device operates in the second mode.

As will be apparent to those skilled in the art from this disclosure, the systems and methods contemplated herein enable the accurate determination of the location of (optionally together with other information about) each of a number of animals while minimising the energy required to do so, thereby providing systems and devices configured or capable of being configured to flexibly control power usage.

Accordingly, in certain embodiments, higher power consuming components present in one or more of the first mobile devices, and/or one or more of the second mobile devices, are capable of being activated or deactivated.

In various embodiments, one or more functionalities present in a mobile device is capable of being activated or deactivated, for example according to a schedule, in response to a manually and/or automatically generated signal that can be (a) internally generated such as battery status, temperature, position, attitude, movement, or the like or (b) externally generated, such as a signal transmitted by a global navigation satellite system or signal generated by the system 100.

In various embodiments, substantially all or all of the first mobile devices are capable of functional equivalence, such as a functional equivalence that is achieved by activating or deactivating one or more functionalities present in the mobile device.

In various embodiments, substantially all or all of the second mobile devices are capable of functional equivalence, such as a functional equivalence that is achieved by activating or deactivating one or more functionalities present in the mobile device.

The low power RF signal may comprise information associated with the precise location of the associated first mobile device 10A-10C.

In some embodiments, the low power RF signal further comprises information about the identity, e.g., a unique slot ID, of the associated mobile device and/or controller.

In some embodiments, the low power RF signal further comprises information about the transmitting power at which the low power RF signal was sent. As will be further elucidated below, the transmitting power may be used by the receiving controller for received signal strength (RSS) calculations.

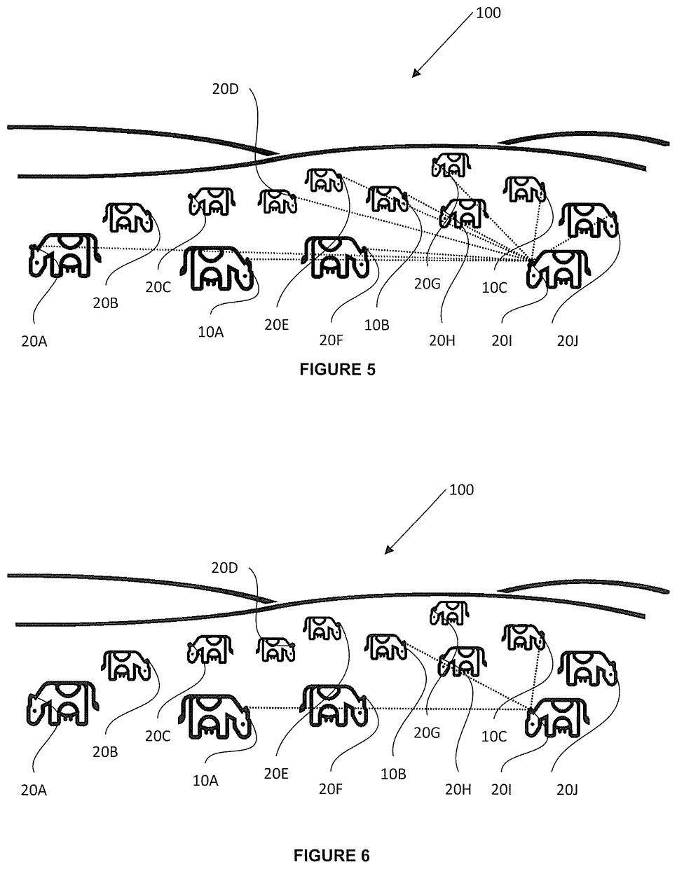

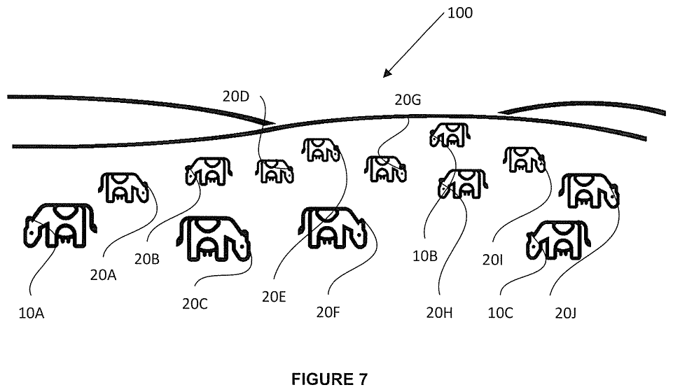

In some embodiments, as shown with reference to FIG. 5, the second RF unit 21 of each second mobile device 20A-20J may optionally be configured to transmit a low power RF signal to be used as a complimentary source of information by other second mobile devices, when determining their estimated location with reference to the first mobile devices, or in conjunction with dead reckoning.

In some embodiments, the first controller 13 is configured to cause the first RF unit 12 to transmit the low power RF signal in accordance with a sequence order assigned for each first mobile device, thereby allowing each first mobile device, by its first controller, to transmit the associated low power RF signal in turn. The sequence order may be based on the identity of the mobile device and/or its first controller.

The second controller 22 may be configured to cause the second RF unit 21 to listen for low power RF signals in accordance with the sequence order of each first mobile device.

Accordingly, the first and second controllers may both have access to the sequence order and having internal clocks being in sync. In some embodiments, the first controller may receive time stamp information from the first satellite positioning unit 11, that forms part of the associated received satellite positioning messages. The first controller 13, may also be configured to include time stamp information in the associated RF signal sent by the first RF unit 12, to the receiving roaming mobile devices.

With reference to the sequence order, the first controller 13 may be further configured to activate the first satellite positioning unit 11 only during a determined first recurring time period, and control the first RF unit 12 to transmit the low power RF signal during a predetermined second time period subsequent to the first time period.

According to some embodiments, a first number of first RF units 12 and a second number of second RF units 21 are configured to form a low power RF partial or full mesh network.

### Positioning Techniques to Estimate Location of the Second Mobile Device

In some embodiments, the RF mesh positioning technique is based on triangulation and/or by determining the received signal strength (RSS), and/or the Angle of Arrival (AoA), and/or Angle of Departure (AoD) of the RF signal or a combination thereof. These techniques and their possible application in the present invention is described in detail below.

### Lateration Using Received Signal Strength (RSS)

The strength of a received RF signal decreases in proportion to the distance of the receiver from the emitter. By understanding what power level the signal was transmitted at, and comparing it to the power level received, a distance between both can be estimated.

Once a low power RF signal is received by the second controller 22, it is configured to calculate an estimated location based on said low power RF signal utilising an RF mesh positioning technique.

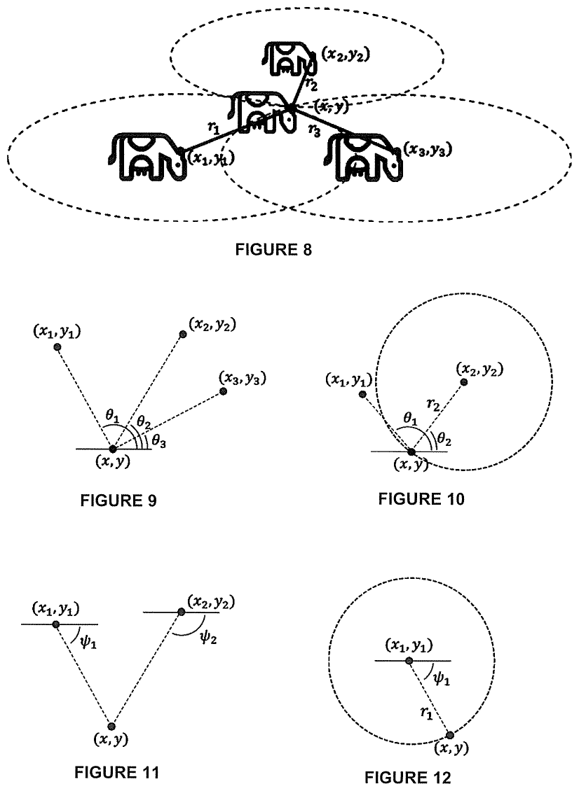

In an embodiment, the RF mesh positioning technique is based on lateration using the RSS. FIG. 8 shows the concept of lateration, in which the position of a target mobile device (x, y) a fixed distance rᵢ from a refence point, (xᵢ, yᵢ) is constrained to the perimeter of a circle given by rᵢ=\sqrt{(xᵢ−x)²+(yᵢ−y)²}.

Using the location of at least three first mobile devices (x₁, y₁), (x₂, y₂), (x₃, y₃) the location (x, y) of the target mobile device may be derived from the following three equations:

$${x}^{2} + {y}^{2} + {α}_{1} x + {b}_{1} y + {c}_{1} = 0$$

$${x}^{2} + {y}^{2} + {α}_{2} x + {b}_{2} y + {c}_{2} = 0$$

$${x}^{2} + {y}^{2} + {α}_{3} x + {b}_{3} y + {c}_{3} = 0 ,$$

$$where {α}_{i} = - 2 {x}_{i} , {b}_{i} = - 2 {y}_{i} , and {c}_{i} = {x}_{i}^{2} + {y}_{i}^{2} - {r}_{i}^{2}$$

### Angle-of-Arrival (AoA)

The angle of arrival measures the apparent phase difference of a beacon as it is received by a pair of antennas with a known spacing between them. With two antenna there will be two possible angles that need to be discriminated between. Signals coming from in front of the antennas will generally be indistinguishable from those coming from behind without requiring any further information.

### Angle-of-Departure (AoD)

For AoD a transmitter will toggle which antenna the signal is transmitted from, the receiver can then analyse the received signal to identify the phase difference and deduce the angle the signal was transmitted at.

It should be appreciated that the deduced angle is not actually the angle it was transmitted at, but more the apparent angle of the portion of the signal that was received and the co-linear plane between the two antennas that radiated it.

### Angulation Using AoA

In an embodiment, as shown with reference to FIG. 9, the RF mesh positioning technique is based on angulation using Angle of Arrival (AoA). The location (x, y) of a target mobile device may be calculated by measuring the AoA, θᵢ from at least three, i≥3, first mobile devices with known locations, (xᵢ, yᵢ).

In some embodiments, where the heading information, e.g., orientation of the target device is known, information from only two first mobile devices may be required to estimate the location of the target device using angulation.

### Lateration Using RSS and Angulation Using AoA

In an embodiment, with reference to FIG. 10, the RF mesh positioning technique is based on a combination of lateration using RSS and angulation using Angle of Arrival (AoA). By combining the angle of arrival measurements θᵢ and distance data rᵢ from the first mobile device calculated from the RSS, it is possible to reduce the required number of first mobile devices, e.g., to one or more. However, the location accuracy and reliability may be improved by calculating the location from a number of first mobile devices to provide a more accurate fix in space.

### Angulation Using AoD

In an embodiment, with reference to FIG. 11, the RF mesh positioning technique is based on angulation using Angle of Departure (AoD). Here, the location (x, y) of a target first mobile device may be determined using the angle Ψᵢ at which a signal departs two or more first mobile devices with known locations (xᵢ, yᵢ) and orientations. The location of the target mobile device may be found at the intersection of the respective lines drawn from the first mobile devices with known location and orientations.

### Lateration Using RSS and Angulation Using AoD

In an embodiment, with reference to FIG. 12, the RF mesh positioning technique is based on a combination of angulation using Angle of Departure (AoD) and lateration using RSS. By using the AoD Ψ₁ from a first mobile device with known position (x₁, y₁) along with the distance r to the first mobile device calculated from the RSS it is possible to determine the location of the target mobile device using one or more first mobile devices, provided the orientation of said first mobile device is known.

### Dead Reckoning Using Sensor and Detector Input

In an embodiment, the second controller 22, may be configured to determine a location of the second mobile device 20A-20J, based on an estimated location derived using the mesh RF positioning technique and optionally in conjunction with a dead reckoning estimated location of the associated mobile device.

The dead reckoning estimated location may be derived from previous location data taken in combination with sensor data from one or more sensors or detectors operatively coupled to the associated controller using conventional dead reckoning techniques.

In some embodiments, as shown in FIG. 13, one or more first mobile devices and/or one or more second mobile device(s) may comprise a motion detector 30 such as an accelerometer or gyroscope and an orientation detector 31 such as a magnetometer.

By utilizing previous location data, identifying a previous location, and an associated time at which the mobile device was located at the previous location as reference, a dead reckoning estimated location may be derived, e.g., using the sensor or detector data.

Hence, the first controller 13 or second controller 22 may be configured to access information from the motion detector 30 and/or orientation detector 31. Based on said accessed information, the controller is configured to determine a temporary location of the associated first mobile device 10A-10C or second mobile device 20A-20J with reference to a previously determined location of the associated first or second mobile device using a dead reckoning technique based on the accessed information, continuously, at regular time intervals, or when prompted by a user via a graphical user interface 50 of a remote device 40.

By accessing multiple readings, e.g., from the motion or orientation detectors, as well as RF signals for location estimation, over time it is possible to determine with a certain level of trust or reliability that any new estimated position is accurate. In some embodiments, a level of trust or reliability (i.e., reliability score) may be determined for each estimated location before all estimated locations are weighted and/or combined based on their respective determined level of reliability in order to produce a final estimated location. In this way, multiple location estimates, e.g., derived from information regarding and/or via the motion detector, orientation detector or via the associated first RF signals, may be combined to form a final location estimate.

Alternatively or additionally, the first mobile device or second mobile device may comprise an audio sensor 32 such as a microphone, or a temperature sensor 33, and/or a heart rate monitor 34, each operatively coupled to the respective first controller 13 and/or second controller 22.

An aim of the present invention is to enhance or at least maintain accurate detection and monitoring of the location of the first and second mobile devices, whilst minimising the overall mobile device power consumption.

As mentioned above in the “Background of the Invention” section, whilst satellite positioning units are ideal for providing a precise location fix in outdoor environments, the process of obtaining the associated satellite position fix requires a considerable amount of power.

A technical effect of the present system is that the overall power consumption is minimised. This is possible by keeping the number of first mobile devices utilizing the power consuming satellite positioning units, i.e., the anchor devices, to a minimum, and calculating the location of the second mobile devices using the RF mesh positioning techniques and/or dead reckoning techniques mentioned above.

In an embodiment, the first mobile device and/or the second mobile device may further comprise a solar panel 35 for providing power to at least one of: the respective satellite positioning unit 11, the first RF unit 12, the second RF unit 21, the first controller 13, or the second controller 22.

Depending on the application the first mobile device 10A-10C and/or the second mobile device 20A-20J may be comprised in or pertaining to at least one of: a tag, such an ear tag, configured to be attached to an ear of the associated animal, a collar configured to be attached around the neck of the associated animal, a pedometer, and a bracelet.

In some embodiments, the mobile device comprises at least one printed circuit board (PCB). In various examples, the at least one PCB comprises any one or more of the aforementioned features of the mobile device, such as the satellite positioning unit, RF unit and controller. It will be appreciated that these components may be provided as through-hole components, or as surface-mount devices (SMD), or a combination thereof.

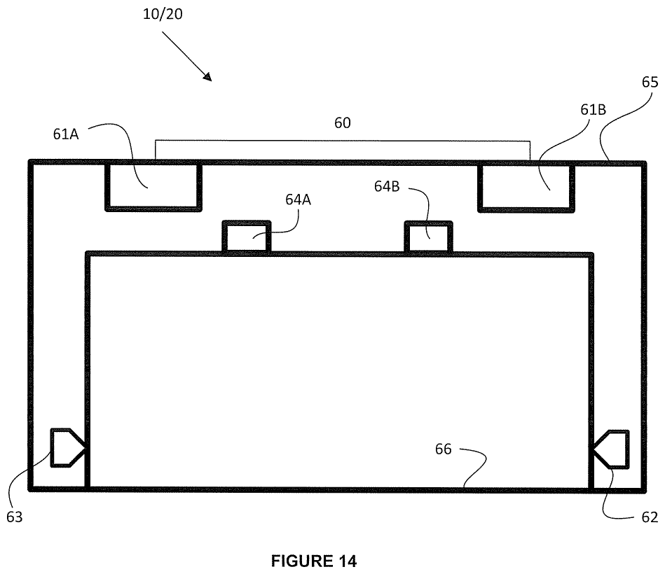

In some embodiments, with reference to FIG. 14, one or more of the multiple mobile devices 10A-10C, 20A-20J may comprise an antenna array 60 having at least two antennas 61A, 61B to enable the implementation of various combinations of positioning techniques, such as the RF mesh positioning and dead reckoning techniques mentioned above. For example, the antenna array 60 may comprise at least two antennas 61A, 61B to facilitate the implementation of the RF mesh positioning technique based on angulation using AoA and/or AoD. In another example, the antenna array 60 may comprise antennas to facilitate the implementation of the RF mesh positioning technique based on a combination of lateration using RSS and angulation using AoA.

In an embodiment, the various antennas of the mobile devices enable a first mobile (anchor) device to employ its satellite positioning unit 11 and/or use RSS to find its own location.

To this end, one or more of the multiple mobile devices 10A-10C, 20A-20J may further comprise positioning means operatively coupled to or forming part of the satellite positioning unit 11 to allow the satellite position unit 11 to detect the precise location of the first mobile device based on received signal(s). The positioning means may comprise one or more second antennas 62. The one or more second antennas 62 may comprise GNSS antenna(s), which may be used for receiving GNSS signals from GNSS satellites.

Further, one or more of the multiple mobile devices 10A-10C, 20A-20J may comprise means for allowing the first mobile (anchor) device to transmit/broadcast this information (including the location of the first mobile device) to other mobile devices in the system 100. This may be achieved by providing one or more third antennas 63 for receiving and/or transmitting information, e.g., using a LoRaWan, Bluetooth, or Zigbee protocol. This allows for the location of the remaining devices to be calculated, for example, by using angulation (e.g., AoA and/or AoD) to find the location of each of the remaining mobile devices relative to the transmitting first mobile devices (the location of which has been established prior to this calculation, as mentioned above). Further examples using different combination of methods for location and/or orientation detection etc. of the mobile devices are contemplated.

The controller may be configured to control and process the abovementioned calculations for detection of the location and/or orientation of the mobile devices. In some embodiments, the controller is configured to select one or more antenna(s) from which signal(s) are to be received from. The one or more antenna(s) may include antenna(s) of the antenna array 60, antenna(s) of the one or more second antennas 62 and antenna(s) of the one or more third antenna(s) 63. The controller may be configured to switch from one antenna to another, such that during a signal of known characteristics (e.g., frequency and/or phase), it is able to perform the required calculations for detecting the location and/or orientation of the mobile device(s) of interest. For example, with regards to AoA or AoD, the controller may be configured to switch between two or more antennas and, using known characteristics such as frequency and phase, calculate a phase difference which corresponds to either an AoA or AoD, depending on whether the selected antenna(s) is/are the transmitter or receiver.

The antenna array 60 may be connected to or form part of the printed circuit board (PCB). Other components such as the second and third antennas 62, and 63 and various units of the mobile device may also be connected to or form part of the PCB. The antenna array 60 may comprise a plurality of antennas equally spaced along a linear/straight, or at least substantially linear/straight, axis. The antennas of the antenna array 60 may be positioned in a Uniform Linear Array (ULA) arrangement, where the antennas are equally spaced apart, along a straight, or at least substantially straight, axis. Alternatively, the antennas of the antenna array 60 may be positioned perpendicularly, or at least substantially perpendicularly, to each other.

In some embodiments, more than two antennas (e.g., three antennas) are provided. In such embodiments, the antennas can be arranged such that they are perpendicular, or at least substantially perpendicular, to each other. For example, each pair of antennas can be positioned perpendicularly, or at least substantially perpendicularly, to each other and/or to other pairs. In this configuration, it can be possible to determine the AoA/AOD in both azimuth and altitude, relative to the device.

In some embodiments, the PCB comprises one or more antennas 61A, 61B (e.g., two antennas) at or proximate to a first edge 65 of the PCB. The antennas of the antenna array 60 may comprise any one or more type of antennas, e.g., dipole Bluetooth antennas. Further, one or more antennas of the antenna array 60 may be uni-directional and/or co-linear. In some embodiments the one or more second and/or third antennas may be positioned at or proximate to a second edge 66 of the PCB. Further, the one or more second antennas and the one or more third antennas may be positioned at or proximate to opposite ends of the second edge 66. The second edge 66 of the PCB may be opposite to the first edge 65 of the PCB.

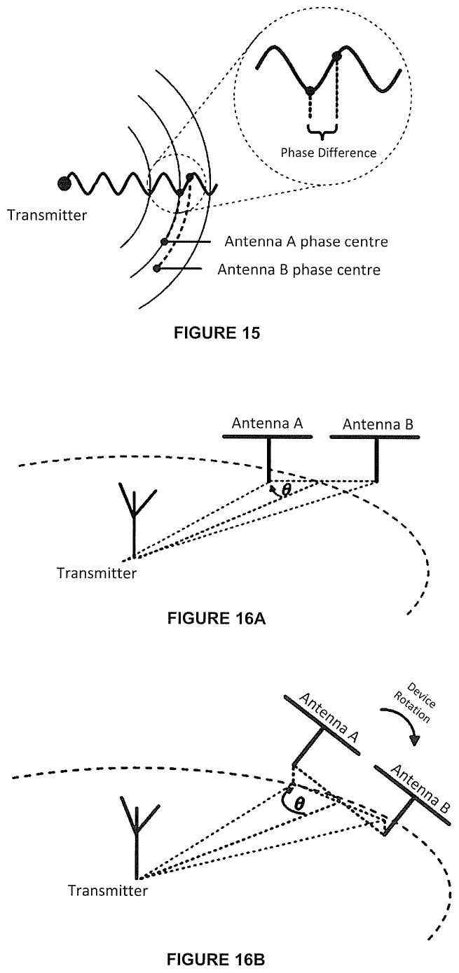

In some embodiments, the RF mesh positioning method is based on using AoA. This method may utilize information extracted through the antenna array 60. In such embodiments, the method relies on linking the AoA information to the phase difference between the signals arriving at the elements of the antenna array 60. In an example, such as that shown in FIG. 14, the antenna array 60 comprises two antennas 61A and 61B. The method of AoA can be based on measuring the phase difference between antennas 61A and 61B which can receive the same (e.g., remotely) transmitted signal from a transmitter. When the antennas of the antenna array 60 are at differing distances from a transmitter, the phase of a steady sinusoid signal received by sampling at integer multiples of the period (of the signal) will result in a steady phase difference—this is graphically demonstrated in FIG. 15. The phase difference can be detected by antenna switching, followed by IQ sampling. This can be enabled by the transmitter adding a constant tone to the data packet causing a specified part of the packet to have a fixed and constant frequency. Knowing this, the receiver can sample the waveform IQ components and determine the phase of the waveform. Thus, by performing these samples for multiple antennas, it can be calculated from which angle the transmitter signal comes from.

In this particular example, the antennas 61A and 61B of the antenna array 60 may be at differing distances from the transmitter and comprise a spacing (d), with an associate wavelength (A). Thus, the phase difference (Φ) between antennas 61A and 61B due to the AoA (θ) can be derived by the following formula:

$$Φ = \frac{2 π}{λ} d sin ( θ )$$

Therefore, the AoA (θ) can be derived by:

$$θ = {sin}^{- 1} \frac{Φ λ}{2 π d}$$

It will be appreciated that due to at least environmental factors, there may be interferences which may have detrimental effects on the performance of the mobile device, especially the one or more antennas of the antenna array 60. Thus, it is important that the designed system recognises and addresses these issues to improve the accuracy and reliability of the mobile device. One of the potential problems posed may potentially reside in waves (e.g., inverse of incoming waves) being reflected, for example from the ground plane of the PCB. This may even be of more concern if the one or more antennas are positioned in close proximity to the PCB ground plane.

To address this potential problem, there may be provided one or more wavetrap(s) (e.g., AoA wavetraps 64A, 64B shown in FIG. 14) which can be used essentially to act as signal filter(s) and/or reduce the shorting effect of the ground plane which reflects the inverse of incoming waves. The wavetrap can be configured to disrupt the boundary current and/or reduce the ground plane reflection. Further, the one or more wavetraps may be SMDs, in order to reduce the physical size of the PCB. In some embodiments, the one or more wavetraps comprise or are provided by one or more tuning capacitors. In this way, the one or more wavetraps may be tuneable.

As mentioned previously, the antennas 61A, 61B of the antenna array 60 may be dipole antennas. Use of dipole antennas in the mobile devices in system 100 can be advantageous in that they possess a relatively constant phase centre, which can be located at the “feeding point”, in order to minimise or redue errors in phase calculations that can be caused by any shifting in the phase centre(s) of the antennas. Further, when antennas are placed relatively close to each other, this may lead to undesired mutual coupling effects. Using dipole antennas also addresses this issue since there is relatively little to zero reception or transmission of power (e.g., RF power) in the direction of the axis of a dipole antenna, which helps to minimise any unwanted antenna coupling.

It will be appreciated that dipole antennas can produce a balanced signal, meaning that a Balun (BALanced-to-Unbalanced) may need to be used to convert the balanced signal to an unbalanced signal, so that it can be received, e.g., by the Bluetooth radio. The mobile device disclosed herein may comprise an SMD balun, in order to at least reduce the physical sized of the component and the PCB overall.

Further, it will be appreciated the physical positioning of the one or more antennas on the mobile device will be important to its functionality, e.g., in terms of reliability and accuracy. As mentioned above, the mobile device may comprise one or more antennas 61A, 61B at or proximate to an edge of the PCB. Alternatively or in addition to this, there may be no obstruction (e.g., by any other components of the mobile device) on the top of the one or more antennas. This is to reduce any obstructions of the one or more antennas which can impede performance, for example by reduce magnitude response, altered phase response or altering the expected functionality of the antennas (e.g., changing the behaviour of the phase centres of dipole antennas). Therefore, the arrangement of the one or more antennas disclosed herein anticipate and address potential detrimental effects that are posed by external factors (e.g., other components of the mobile device).

The system 100 can be arranged such that an antenna array 60 (e.g., an AoA antenna array) is incorporated into one or more of the first mobile devices 10A-10C and/or one or more second mobile devices 20A-20J. In some embodiments, all of the first mobile devices and second mobile devices comprise an antenna array 60. This provides any of the first and/or second mobile devices comprising the antenna array 60 with the ability to locate their own position, locate the position of other mobile devices, and operate as a mobile receiver as well as a mobile transmitter, allowing each of the mobile devices to receive and transmit messages and positioning information to/from the other mobile devices in the system 100. Further, it allows the operation mode of a second mobile device (i.e., a roaming device) to be changed to that of a first mobile device (i.e., an anchor device), and/or vice versa.

As a result, it is therefore possible to provide a system/network of mobile devices where each mobile device embodies or comprises the capability to locate itself and/or other mobile devices in the system 100.

The antenna array 60 may be arranged such that it comprises suitable physical attributes for its application, e.g., thickness, dimensions, shape and material, while still being able to adequately perform its intended functions. This essentially minimizes any physical and functional design limitations and allows the mobile device to adopt the required functionality without having to compensate on the physical arrangement of the mobile device. This makes the present invention particularly ideal, for example, for dense, adjustable and/or moving network applications (such as a herd of animals) where different targets/subgroups can be in close proximity to each other and it is not possible (or it is not preferred) to have any stationary reference points in the system (e.g., bases or stations).

The antenna array 60 may facilitate the implementation of various positioning techniques that are suitable to both the first mobile (anchor) device and/or the second mobile (roaming) device while still comprising an appropriate physical configuration for attaching to an animal. For example, in an application where the mobile device may be comprised in or pertaining to be a device (such as an ear tag) attached to an animal, the PCB (and therefore the antenna array 60) thereof is physically and functionally suitable to be attached to the animal via the mobile device, such as the ear tag. For this purpose, the PCB size may be small enough to be attached to and carried around by the animal without causing any adverse effects on the animal, while still operating to provide the abovementioned functionalities of an anchor device and/or a roaming device, such as detecting, transmitting and/or receiving the position of the respective mobile device (and therefore animal) and other mobile devices in the system, for example using the AoA and/or AoD methods. Since the respective mobile device is able to transmit information about its location to other devices, such as via antenna 62, it mitigates the need for a fixed and/or permanent base/station having a known location, since the animal itself can be used as a reference point (i.e., an anchor device) for locating itself and/or the remaining animals in the herd.

As the animal attached with a mobile device moves around, this will affect the orientation of the mobile device, e.g., with reference to a vertical (gravitational) axis. To accurately detect the angle to/from another transmitting mobile device, detection of the current orientation of the mobile device is desired. In some embodiments, each mobile device is configured such that it regularly monitors its own attachment position and/or orientation when in use, in order to account and/or compensate for any changes that may occur. For example, if the mobile device rotates around an axis that is perpendicular or at least substantially perpendicular to a particular plane of the mobile device, the apparent AoA (θ) from a transmitter will shift (e.g., towards 90 degrees), as shown with reference to FIGS. 16A and 16B. By utilizing the motion sensor 30 (e.g., accelerometer or gyroscope) and/or the orientation detector 31 (e.g., magnetometer), the apparent AoA (having shifted) can be detected and measured, meaning that the difference caused by the shift can be accounted for and corrected in the calculations. The first controller 13 of the associated mobile device may thus be arranged to access information from the motion sensor 30, and/or the orientation detector 31 to detect a current orientation of the mobile device (within the global coordinate system) and correct for the said orientation when deriving the AoA (in said global coordinate system).

In some embodiments, trigonometric methods may be used to account for the difference caused by the shift. In a case of a rotation around an axis that is perpendicular or at least substantially perpendicular to a plane of the mobile device, such as the tag, the rotation angle can be used to translate measurements and/or calculations using trigonometric methods, such that they are suitable for performing positioning calculations. For example, using trigonometric methods, a rotation angle can be used to translate a calculated AoA or AoD (e.g., calculated via the antenna array 60) to the 2D projection of this rotation angle, such that positioning calculations can be performed. Those skilled in the art would understand that various methods can be used for monitoring and compensating for any changes to the position and/or orientation of the mobile device.

In some embodiments and/or configurations, in the presence of a change in the position and/or orientation of the mobile device and the calculations approaching a degenerate point, the sensitivity to the correct angle decreases. For example, when having a change in position and/or orientation (e.g., a tilt) of 90 degrees, there is no, or very small amount of, angular change regardless of AoA. Therefore, the calculations can become more susceptible to noise.

In some embodiments, the mobile device is affixed such that it is free to pivot on the animal (e.g., on a cow's ear), such that in most (if not all) static situations gravity will ensure that it remains optimally oriented.

In some embodiments, as shown in FIG. 13, the system 100 may further comprise a remote device 40 for receiving data from the first mobile device(s) 10A-10C10C and/or the second mobile device(s) 20A-20J20J. The system may further comprise a graphical user interface (GUI) 50 configured to present the received data, and optionally control operation of one or more parameters of the first mobile device(s) 10A-10C10C and/or second mobile device(s) 20A-20J20J.

In some embodiments, the operator may control the operation mode of the first mobile device and/or second mobile device using the GUI, e.g., by changing the operation mode of a second mobile “roaming” device to that of a first mobile “anchor” device, or vice versa.

The remote device 40 and/or the graphical user interface 50 may form part of a mobile phone, smart phone, tablet, smart watch, computer, display device and the like.

In various embodiments, the first mobile device comprises a satellite positioning unit 11 and a first radio frequency (RF) unit 12.

In certain embodiments, the satellite positioning unit 11 receives data from a Global Navigation Satellite System (GNSS). For example, the satellite positioning unit 11 is a GNSS unit or receiver.

The present invention is not limited to any particular type of satellite positioning system. For example, the GNSS unit, may be e.g., a Global Positioning System (GPS) unit having a position sensor or receiver for receiving GPS data, or GLONASS unit having a position sensor or receiver for receiving GLONASS data.

In some embodiments, the satellite positioning unit 11 is an assisted GPS unit arranged to receive Almanac and Ephemeris data using a Long Range Wide Area Network (LoRaWAN) communications protocol from a remote stationary device.

In some embodiment each first mobile device 10A-10C may further comprise a first transceiver 14 arranged to transmit and/or receive said Almanac and Ephmeris data to/from another mobile device.

It should be appreciated that each second mobile devices may also comprise a transceiver arranged to transmit and/or receive said Almanac and Ephemeris data to/from another mobile device, when said second mobile device is set to operate (according to the first operation mode) as a first mobile device.

In certain embodiments, the first transceiver 14 is configured to transmit/receive information using a LoRaWAN, Bluetooth, or Zigbee, WIFI or any other suitable communication protocol.

In certain embodiments, the satellite positioning unit 11 receives Galileo data. For example, the satellite positioning unit 11 is a Galileo position sensor or a Galileo receiver.

In certain embodiments, the satellite positioning unit 11 receives BeiDou, NavID, or QZSS data. For example, the satellite positioning unit 11 may be a sensor or a receiver capable of receiving BeiDou, NavID, and/or QZSS data.

It will be appreciated that data from more than one satellite navigation system can be received, and units capable of combining data from more than one satellite navigation system are suitable for use with the systems and methods described herein.

Generally, the satellite positioning unit 11, such as a sensor/receiver capable of receiving satellite data, is capable of determining one or more of longitude, latitude, altitude, and/or horizon position, such as one or more of the longitude, latitude, altitude, and/or horizon position of the animal to which it is affixed or associated with. Locating position information of an object with a satellite positioning unit such as a sensor is well known in the art. Essentially, a satellite positioning unit such as a GPS or GNSS sensor/receiver calculates its position by receiving precise timing information associated with each signal transmitted by positioning satellites orbiting the Earth. While systems may be configured in different ways, usually each satellite continually transmits signal data that includes the time the data was transmitted, precise orbital information (the ephemeris), the general system health, and rough orbits of all system satellites (the almanac). The satellite positioning unit such as a GPS, Galileo, or GLONASS sensor/receiver will then typically determine from the data it receives the transit time of each signal and compute the distance to each satellite. These distances, along with the satellites' locations, are used (with the possible aid of trilateration) to compute the position of the satellite positioning unit, and therefore an animal to which the unit may be attached.

In certain embodiments, the system additionally comprises a unit capable of receiving data from a local positioning system (LPS). LPSs will typically use one or more beacons, such as cellular base stations, Wi-Fi access points, Bluetooth, and/or radio broadcast towers to compute the position of a unit such as an LPS receiver/sensor, and therefore the position of an animal to which the LPS positioning unit is attached. In one embodiment, certain data that is capable of being received from a satellite navigation system is instead received by one or more of the first mobile devices from a local positioning system. In one embodiment, data relating to a satellite navigation system, such as ephemeris data and/or almanac data, is received from the LPS, such as from a Long Range Wide Area Network (LoRaWAN), instead of or in addition to such data directly from one or more satellites. In another embodiment, the LPS transmits data other than that transmitted by or utilised in a satellite navigation system. Such data could include localised weather information, data about locations of particular concern and the like.

In certain embodiments, the LPS utilises data transmitted from one or more transmitters having a precisely known location.

In some embodiments, the first transceiver 14, or first controller 13 is further arranged to receive a precise location of a remote stationary GNSS receiver or external device with a known precise location. The GNSS receiver or external device may be operatively coupled to a third RF unit for transmitting an RF signal comprising its location to any mobile devices being within coverage.

In this way, the first or second controller may be further configured to determine its location in relation to the precise location of the remote stationary GNSS receiver or external device based on the one or more received RF signals utilizing an RF mesh positioning technique.

In some embodiments, the first controller 13 may be configured to receive information about the precise location of a remote stationary beacon provided with a location of a GNSS receiver such as a mobile phone, in a RF signal.

An external GNSS receiver or external device with known location may be particularly advantageous for indoor applications, e.g., within a milking shed or barn.

The mobile devices each comprise an RF unit. In various embodiments, the first mobile device(s) comprises a first RF unit capable of transmitting one or more RF signals, such as one or more low power RF signals, and the second mobile devices comprise a second RF unit capable of receiving one or more of the RF signals transmitted by one or more first RF units.

In certain specifically contemplated embodiments, the first RF unit(s) and the second RF unit(s) differ. In certain examples the first RF unit(s) and the second RF unit(s) are physically different. In other examples, the first RF unit(s) and the second RF unit(s) are functionally different or are capable of being configured so as to be functionally different. In one example, the first RF unit(s) are capable of both transmitting and receiving, whereas the second RF unit(s) are capable of receiving only. In another example, the first RF unit(s) and the second RF unit(s) are capable of being configured to have differing functionalities, such as the ability to transmit signal, or the nature of the signal transmitted or received (including, for example, the power and/or frequency at which the signal is transmitted or received, the data being transmitted or received, how frequently the signal is transmitted or received, and the like).

In certain embodiments, one or more of the second mobile devices are capable of themselves transmitting one or more RF signals. Accordingly, in one example, the first RF unit(s) and the second RF unit(s) are each capable of both transmitting and receiving. The transmitting functionality of the second mobile device(s) in certain embodiments is present in the second RF unit itself, while in other embodiments it is present in a separate RF unit present in one or more of the second mobile device(s).

One or more of the mobile devices comprises a controller. In one embodiment, one or more of the first mobile devices comprises a controller, such as a controller capable of controlling the operation of one or more of the satellite positioning units, the first RF unit, power consumption, and/or battery maintenance.

In one embodiment, each of the second mobile devices comprises a controller capable of determining a location of the second mobile device. In particularly contemplated embodiments, the location is determined in relation to one or more of the first mobile devices from which an RF signal is received.

Additionally or alternatively, the location is determined in relation to one or more second mobile devices from which an RF signal, such as a signal comprising data suitable for mesh positioning, is received.

The frequency for determining the precise location of each first mobile device, is controlled by the associated controller. For example, the frequency may be set higher during daylight hours when the animals are moving more frequently than during non-daylight hours when the animals are normally asleep.

The frequency for determining the precise location may also be set to a certain value during specific time periods, or set triggered based on an event, e.g., when a leader animal is moving to a certain extent.

The frequency could also be set based on the geographical location, e.g., milking shed, of the mobile device.

In some embodiments, the controller may activate the satellite positioning unit 11 based on an anomaly event, e.g., when the motion detector an acceleration greater than a threshold.

It should be appreciated that the number of first mobile devices may change due to the overall location performance. For example, if the location of a certain second mobile device has been determined using only dead reckoning techniques for a considerable amount of time, i.e., without RF mesh technique calculations, the associated controller could trigger the onboard satellite position unit to obtain a precise location fix.

In some embodiments, the first number of mobile devices is lower than the second number of second mobile devices.

It should be appreciated that the mobile devices acting as first mobile devices may be dynamically selected based on an anchor selection sequence.

In some embodiments, the anchor selection sequence is carried out locally by the first controller 13a-13c. Alternatively, the anchor selection sequence may be carried out on an external device, e.g., a server, or a cloud-based service device, e.g., as cloud server.

The anchor selection sequence may be triggered when a certain selection or replacement criterion or criteria is met.

In general, the selection or replacement criterion or criteria may be considered met when the first mobile device is no longer suitable to act as a first mobile device, or alternatively when any one of the second mobile devices is more suitable to act as a first mobile device.

In some embodiments, the first mobile devices are randomly selected.

There are some situations where it may be advantageous for a particular first mobile device to be functionally replaced by another second mobile device. For example, such a situation could arise if the first mobile device is located closely to another first mobile device, or when its battery level is below a certain threshold, or when the first mobile device is relatively remote to the rest of the mobile devices and/or is moving beyond a certain threshold.

When the selection or replacement criterion or criteria is met, the associated first controller 13 is configured to transmit, by the associated first RF unit, a replacement signal associated with a request for replacement when a certain criterion for replacement is met, receive one or more RF response signals in response to its transmitted replacement signal from a second mobile unit, identify the second mobile unit whose RF response signal is best suited for the replacement, transmit an RF confirmation signal for receipt by the identified second mobile unit, receive an RF affirmation signal from the identified second mobile unit, and in response to the RF affirmation signal, reset the operation of the associated first mobile unit acting as an anchor device to that of a second mobile unit acting as a roaming device.

When the anchor selection sequence is set to be carried out locally, each second controller 22 is configured to: receive, by the associated second RF unit, a replacement RF signal from a first controller, and in response to said received replacement signal, transmit an RF response signal comprising information about its associated second mobile device's suitability to replace the first mobile device associated with the transmitted the replacement signal as a new anchor device, receive an RF confirmation signal from the first controller transmitting the RF replacement signal, and in response thereto, transmit an RF affirmation signal confirming the replacement, and reset the operation of the associated second mobile unit acting as a roaming device to that of a first mobile unit acting as an anchor device.

When the anchor selection sequence is carried out on an external device, e.g., in the cloud, the outcome is relayed back to the mobile devices.

In this embodiment, each of the mobile device may transmit data relating to the selection or replacement criterion or criteria. It should be appreciated that up-to-date selection or replacement criterion data may already be accessible in the cloud, so it may not be required to transmit all data at once. Based on the received data the cloud-based device is configured to compute a weighting for each mobile device based on a weighting criterion or criteria. The cloud-based device is further configured to identify a set of optimal first mobile devices for a next round of localisation determination. An adaptive Poisson disk sample elimination algorithm may be utilized to identify the set of optimal first mobile devices for the next localisation determination. The cloud-based device is further configured to transmit a message to each of the tags with information about whether it should operate as a first mobile device, i.e., anchor device, or second mobile device, i.e. roaming device. The message may be transmitted in a downlink broadcast occurring at a prescheduled time. Based on the received information, each respective controller is configured to execute the associated first (anchor) or second (roaming) operation mode.

Compared to a local anchor selection sequence an external anchor selection sequence, such as a cloud-based anchor selection sequence, may have access to some or all information about the other mobile devices of the system. Having access to more information may lead to an overall optimisation of the selection sequence, at the cost of higher power consumption associated with transmitting said information. On the other hand, a local anchor selection sequence uses less information and saves power.

The selection or replacement criteria or criterion may be based on one or more of the following:
The battery level of the battery of the associated mobile device
The location of the associated mobile device
   As some time has passed since the last location update process was completed this location is likely to be an estimate based on dead reckoning. However, if the tag was previously an Anchor tag and the animal did not move since the GNSS was used, then the location reported will be the GPS location.
Confidence of location
   Dilution of precision
      For mobile devices that have acquired their position via GNSS the value of dilution of precision will come directly from the associated GNSS receiver. The dilution of precision is a metric that GNSS systems use to provide an understanding of the accuracy of a position estimate based on knowledge of the information that was used to generate the estimate.
      For mobile devices that have been localised using the RF mesh positioning technique, the dilution of precision may be derived from the associated lateration, and/or angulation calculations. It can be directly related to estimating position from RF metrics such as RSS and AoA/AoD.
   Distribution of errors-taking into consideration the accuracy and precision of multiple readings, using Circular Error Probable or circular bivariate calculations. The circular error probable, also referred to as the median error radius, is defined as the radius of a circle, centred on the mean, whose perimeter is expected to include 50% of the points.
Activity state
The activity state refers to the active behavioural state of the animal to which the mobile device is attached. Generally, stationary mobile devices are preferred over mobile devices associated with high activity as the location estimates may be determined with a higher level of trust.
Orientation
The estimated orientation of the animal as a compass bearing and the actual orientation of the tag as reported by the onboard sensors.
   The weighting criteria may be associated with any of the following:
Location of the animal
This may include the relative location to other mobile devices, the spatial density of mobile devices within the group of mobile devices, and the mobile device's location within the geographic location, e.g., farm. Areas with obstacles such as hills, trees, or farm buildings may need special consideration by the selection algorithm.
Activity state of the mobile device
Location of confidence metrics (as further elucidated above).

As used in this specification, the words “comprise”, “comprises”, “comprising”, and similar words, are not to be interpreted in an exclusive or exhaustive sense. In other words, they are intended to mean “including, but not limited to”. When interpreting each statement in this specification that includes the term “comprise”, “comprises”, or “comprising”, features other than that or those prefaced by the term may also be present.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

The invention may also be said broadly to consist in the parts, elements and features referred to or indicated in the specification of the application, individually or collectively, in any or all combinations of two or more of said parts, elements or features.

Aspects of the invention have been described by way of example only, and it should be appreciated that variations, modifications and additions may be made without departing from the scope of the invention, for example when present the invention as defined in the indicative claims. Furthermore, where known equivalents exist to specific features, such equivalents are incorporated as if specifically referred in this specification.

1. A system for determining the location of a number of animals in a group of animals, comprising
a first number of first mobile devices forming anchor devices, each configured to be attached to an animal of a first subgroup of the group of animals, each first mobile device comprising
a satellite positioning unit for detecting a precise location of the first mobile device, and
a first radio frequency (RF) unit for transmitting a low power RF signal, and
a first controller for controlling the operation of the satellite positioning unit and the first RF unit,
a second number of second mobile devices forming roaming devices, each configured to be attached an animal of a second subgroup of the group of animals, each second mobile device comprising
a second radio frequency (RF) unit for receiving one or more RF signals transmitted by the first number of first mobile devices, and
a second controller configured to determine a location or relative location of the second mobile device based on the one or more received RF signals utilizing an RF mesh positioning technique.

2. The system according to claim 1, wherein the low power RF signal comprises information associated with the precise location of the associated first mobile device.

3. The system according to claim 1 or 2, wherein the first controller is configured to cause the first RF unit to transmit the low power RF signal in accordance with a sequence order assigned for each first mobile device, thereby allowing each first mobile device, by its first controller, to transmit the associated low power RF signal in turn.

4. The system according to claim 3, wherein the second controller is configured to cause the second RF unit to listen for low power RF signals in accordance with the sequence order of each first mobile device.

5. The system according to any one of the preceding claims, wherein the RF mesh positioning technique is based on triangulation and/or by determining the received signal strength (RSS), and/or the Angle of Arrival (AoA), and/or Angle of Departure (AoD) of the RF signal.

6. The system according to any one of the preceding claims, wherein the first number is lower than the second number.

7. The system according to any one of the preceding claims, wherein the first number of first RF units and the second number of second RF units are configured to form a low power RF partial or full mesh network.

8. The system according to any one of the preceding claims, wherein the satellite positioning unit is a Global Navigation Satellite System (GNSS) unit, such as a Global Positioning System (GPS), or GLONASS unit.

9. The system according to claim 8, wherein the GNSS unit is an assisted GPS unit arranged to receive Almanac and Ephemeris data using a Long Range Wide Area Network (LoRaWAN) communications protocol from a remote stationary device.

10. The system according to claim 9, each first mobile device further comprises a first transceiver arranged to transmit and/or receive said Almanac and Ephmeris data to/from another first mobile device.

11. The system according to claim 10, wherein the first transceiver is configured to transmit/receive information using a LoRaWAN, Bluetooth, or Zigbee protocol.

12. The system (100) according to claim 10 or 11, wherein the first transceiver is further arranged to receive a precise location of a remote stationary GNSS receiver or external device with a known location.

13. The system according to claim 12, wherein the second radio frequency (RF) unit is further configured to:
determine its location in relation to the precise location of the remote stationary GNSS receiver based on the one or more received RF signals utilizing an RF mesh positioning technique.

14. The system according to any one of the preceding claims, wherein at least one of the first number of first mobile devices and/or at least one of the second number of second mobile devices further comprises at least one of the following: a motion detector such as an accelerometer or gyroscope, an orientation detector such as a magnetometer, an audio sensor such as a microphone, or a temperature sensor, and/or a heart rate monitor.

15. The system according to claim 14, wherein the motion detector, orientation detector, audio sensor, temperature sensor, and/or a heart rate monitor is operatively coupled to the respective first controller and/or second controller.

16. The system according to any one of the preceding claims, wherein the first mobile device and/or the second mobile device further comprise: a solar panel for providing power to at least one of: the respective satellite positioning unit, the first RF unit, the second RF unit, the first controller, or the second controller.

17. The system according to any one of the preceding claims, wherein the first controller is further configured to:
activate the satellite positioning device only during a determined first recurring time period, and
control the first radio frequency (RF) unit to transmit a low power RF signal during a predetermined second time period subsequent to the first time period.

18. The system according to claim 14 or any claim dependent thereon, wherein
the first controller or second controller is further configured to:
access information from the motion detector or orientation detector, and
determine a temporary location of the associated first mobile device or second mobile device with reference to a previously determined location of the associated first or second mobile device using a dead reckoning technique based on the accessed information continuously, at regular time intervals, or when prompted by a user via a graphical user interface.

19. The system according to any one of the preceding claims, wherein the first mobile device and/or the second mobile device pertains to at least one of:
an ear tag configured to be attached to an ear of the associated animal,
a collar configured to be attached around the neck of the associated animal,
a pedometer, and
a bracelet.

20. The system according to any one of the preceding claims, further comprising
a remote device for receiving data from the first mobile device(s) and/or the second mobile device(s), and
a graphical user interface configured to:
present the received data, and/or
control operation parameters of the first mobile device(s) and/or second mobile device(s).

21. The system according to claim 20, wherein the remote device and/or the graphical user interface forms part of a mobile phone, smart phone, tablet, smart watch, computer and/or display device.

22. The system according to any one of the preceding claims, wherein each first mobile device of the first number of first mobile devices is selected based on an anchor selection sequence carried out locally by the first controller or externally on a cloud-based service device.

23. The system according to claim 22, any one of the preceding claims, wherein when the anchor selection sequence is set to be carried out locally, when a certain criterion for requesting for replacement is met,
the associated first controller is further configured to
transmit, by the associated first RF unit, a replacement signal associated with a request for replacement when a certain criterion for replacement is met,
receive one or more RF response signals in response to its transmitted replacement signal from a second mobile unit,
identify the second mobile unit whose RF response signal is best suited for the replacement,
transmit an RF confirmation signal for receipt by the identified second mobile unit,
receive an RF affirmation signal from the identified second mobile unit, and in response to the RF affirmation signal
reset the operation of the associated first mobile unit acting as an anchor device to that of a second mobile unit acting as a roaming device.

24. The system according to claim 22 or 23, wherein when the anchor selection sequence is set to be carried out locally,
each second controller is configured to:
receive, by the associated second RF unit, a replacement RF signal from a first controller, and in response to said received replacement signal,
transmit an RF response signal comprising information about its associated second mobile device's suitability to replace the first mobile device associated with the transmitted the replacement signal as a new anchor device,
receive an RF confirmation signal from the first controller transmitting the RF replacement signal, and in response thereto
transmit an RF affirmation signal confirming the replacement, and
reset the operation of the associated second mobile unit acting as a roaming device to that of a first mobile unit acting as an anchor device.

25. The system according to any one of claims 1 to 24, wherein one or more first devices and/or one or more second mobile devices comprise(s) a respective antenna array having at least a first antenna and a second antenna spaced apart by a known spacing.

26, The system according to claim 25, wherein the at least one first antenna and at least one second antenna is a dipole antenna.

27. The system according to claim 25 or 26, wherein the at least one first antenna and at least one second antenna are uni-directional and/or co-linearly arranged.

28. The system according to any one of claims 25 to 27, wherein the at least one first antenna and at least one second antenna are arranged at or proximate an edge of a printed circuit board of the first mobile device and/or second mobile device.

29. The system according to any one of claims 25 to 28, wherein one or more first devices and/or one or more second mobile devices comprise(s) at least one wavetrap acting as a signal filter.

30. A device for determining the location of an animal that the device is configured to be attached thereto, the device comprising:
a printed circuit board (PCB); and
an antenna array comprising one or more antennas,
wherein the two or more antennas are positioned at or proximate to a first edge of the PCB.

31. The device of claim 30, wherein the one or more antennas of the antenna array are arranged in a linear, or at least substantially linear axis.

32. The device of claim 30 or 31, wherein the device comprises one or more second antenna(s).

33. The device of any one of claims 30 to 32, wherein the device comprises one or more third antenna(s).

34. The device of claim 32, wherein the one or more second antenna(s) comprise GNSS antennas(s).

35. The device of claim 33, wherein the one or more third antenna(s) are configured to use a LoRaWAN, Bluetooth, or Zigbee protocol.

36. The device of claim 32 or 33, wherein the one or more second antennas are positioned on the PCB at or proximate to a second edge of the PCB, wherein the second edge is opposite the first edge.

37. The device of any one of claims 30 to 36, comprising one or more wavetrap(s).

38. The device of claim 37, wherein the one or more wavetrap(s) comprise or are provided by one or more tuning capacitors.
